(19) United States
(12) Patent Application Publication
(10) Pub. No.: US 2006/0178769 A1
(43) Pub. Date: Aug. 10, 2006

(54) Making honeycomb extrusion dies

(76) Inventors: Thomas William Brew, Corning, NY (US); Yawei Sun, Horseheads, NY (US); David Robertson Treacy JR., Elmira, NY (US); Jennifer Jane Walker, Painted Post, NY (US)

Correspondence Address: CORNING INCORPORATED, SP-TI-3-1, CORNING, NY, 14831, US

(21) Appl. No.: 11/296,593

(22) Filed: Dec. 6, 2005

Related U.S. Application Data
(60) Provisional application No. 60/635,036, filed on Dec. 9, 2004.

(51) Int. Cl. G06F 19/00; G06F 7/66; B29C 47/12; B29C 47/92

(52) U.S. Cl. 700/122; 264/40.7; 264/177.12; 700/196

(57) ABSTRACT

Variations in extrusion speed or flowfront shape across the outlet faces of honeycomb extrusion dies are predicted from variations in die geometry across multiple die extrusion zones, based on data correlating the variables to the variations in extrusion speed or flowfront shape, or on calculations of the pressure drops to be experienced by extrudable materials traversing the extrusion zones, adjusting the variations through die processing as desired to appropriately modify die geometry prior to use of the die in an extruder.

This application claims the benefit of U.S. Provisional Application No. 60/635,036, filed Dec. 9, 2004, entitled “Making Honeycomb Extrusion Dies”.

### BACKGROUND OF THE INVENTION

The present invention relates to the manufacture of ceramic honeycombs of the kind used as catalyst supports or ceramic filters for the control of combustion exhaust emissions from motor vehicle engines or other fuel combustion processes. More particularly, the invention relates to improved honeycomb extrusion dies and extrusion processes for improving manufacturing efficiencies in the production of such honeycombs.

The presently preferred commercial method for manufacturing honeycomb structures from ceramic materials involves the shaping of plasticized ceramic powder batch mixtures into honeycomb by extrusion through metal honeycomb dies. Generally, such dies comprise solid metal blocks incorporating an array of batch feedholes on an inlet face, and an array of honeycomb discharge slots on a discharge or outlet face, the discharge slots connecting with the batch feedholes at feedhole-slot junctions or transfer points disposed within the body of the die. U.S. Pat. Nos. 3,790,654 and 3,885,977 are early patents describing the production of such honeycombs.

A common problem arising in the manufacture of ceramic honeycombs by extrusion processes is that of extrudate deformation caused by uneven extrusion rates (extrudate outflow speeds) occurring across the discharge face of the die. Thus inherent die and extruder attributes leading to uneven extrudate flow behavior can cause defects such as bowing (bending of the extrudate), honeycomb wall (web) and/or channel deformities, and in severe cases a cracking apart of the extrudate as it exits the die.

Conventional approaches to address these die performance problems include simply testing the extrusion behavior of each die on an extruder and, if unsatisfactory for a reason relating to uneven extrudate flow, to selectively re-machine the die by selectively passing honeycomb batch or other abrasive material through slow-flowing die sections for extended times to improve the uniformity of extrudate flow therethrough. Alternatively, the dies can simply be “run in” by leaving them in production until die wear from the flowing ceramic batch eventually produces more even extrudate flowfront.

More recently, a number of mechanical approaches for addressing uneven extrudate flow have been developed. Representative of such approaches are those disclosed, for example, in U.S. Pat. Nos. 6,039,908, 6,663,378 and in published U.S. Patent Application No. U.S. 20040164464 A1. In general, these approaches involve the use of flow control hardware upstream of the extrusion dies, most typically to control extruder pressure behind the die to compensate for uneven die performance.

The shortcomings of the various known mechanical flow control solutions are several. Mechanical upstream pressure controls typically add equipment cost and process control complexity to honeycomb manufacturing, while approaches involving die “run-in” result in the non-productive use of manufacturing equipment, and in some cases the production of large quantities of extruded material that has to be recycled or disposed of at high cost. Die re-machining to correct extrusion non-uniformity results in the partial removal of die wear coatings, reducing die service life and necessitating expensive re-coating of the dies. Thus substantial problems arising from the uneven extrusion performance of conventionally manufactured honeycomb extrusion dies remain.

### SUMMARY OF THE INVENTION

The present invention provides methods for more efficiently manufacturing extruded honeycomb structures, by creating more desirable initial extrudate flow behavior in honeycomb extrusion dies. Thus the waste and lost manufacturing time incurred when new but poorly-performing dies must be taken back out of production for re-machining are minimized or avoided. By desirable extrudate flow behavior is meant a flow behavior wherein extrudate bowing, honeycomb channel distortion, and/or extrudate splitting caused by more rapid flow of the extrudate through some sections across the die discharge face than others are reduced or eliminated.

The method of the invention generally involves measuring and modifying die attributes affecting extrudate flow before the die is put into use for honeycomb extrusion. In preferred embodiments, die extrudate flow behavior is first projected from direct measurements of selected geometric attributes of machined extrusion dies, and the dies are then modified prior to use in production, for example by selective machining and/or selective coating of the dies to modify the measured geometric attributes. Using this approach, the resulting dies can be put into use in production with high initial production yields, and therefore without the need to scrap initial product or stop production for the purpose of modifying the die.

In a first aspect, therefore, the invention includes a method for predicting extrudate flow differentials giving rise to flowfront variations across the discharge face of an extrusion die. That method comprises, first, selecting a honeycomb extrusion die comprising extrudate feedholes extending into a die body from a die inlet face and crisscrossing honeycomb discharge slots extending into the die from an opposing die outlet face, the discharge slots intersecting and forming feedhole-slot intersections with the extrudate feedholes.

The physical characteristics of the selected extrusion die are then determined by measurements of the shapes, dimensions, and/or surface characteristics of at least the die feedholes and the die discharge slots. The measurements are generally taken at multiple sampling locations or extrusion zones through the die, each extrusion zone consisting of a cross-sectional die volume extending from a defined area or zone on the die outlet face through the die to the die inlet face in the direction of extrudate flow through the die, that extrusion zone thus encompassing all of the feedholes and discharge slots located within that volume of the die. The characteristics of the feedhole-slot intersections within each of such locations or extrusion zones may also be measured.

Data derived from the measurements thus taken are then used to predict extrudate flow differentials, for example through calculations of extrudate pressure drops giving rise to flow rate differentials among the multiple extrusion zones, so that locations likely to exhibit high flow rates and locations likely to exhibit low flow rates can be identified. Alternatively, extrudate flow differentials, particularly including those creating flow rate patterns giving rise to honeycomb cell distortion or extrudate bowing or bending from the extrusion direction in the course of extrusion, can be predicted by reference to a data set correlating such flow rate patterns to patterned variations in the geometric die parameters measured for the various extrusion zones across the extrusion die.

Application of these flowfront projection techniques results in a significantly improved method for making a honeycomb extrusion die. That method comprises, first, fabricating a honeycomb extrusion die comprising extrudate feedholes extending into a die body from a die inlet face, and forming criss-crossing honeycomb discharge slots extending into the die from an opposing die outlet face, the discharge slots being extended to form feedhole-slot intersections with the extrudate feedholes.

The physical characteristics of the thus-fabricated die that may give rise to flowfront variations are then determined as above described, by measuring the geometry, i.e., the shapes, dimensions, and/or surface characteristics of at least the feedholes and the discharge slots at multiple sampling locations across the die outlet face. Data from these measurements are then used to calculate extrudate flow rate differentials among the multiple locations across the die outlet face, such differentials depending upon calculated variations in, for example, extrudate flow impedance or extrudate pressure drop among those locations.

Finally, the shapes, dimensions, and/or surface characteristics of the feedholes and/or discharge slots at one or more of the multiple locations are modified to reduce the calculated flow rate differentials. Conventional die machining or coating methods can be used to modify those shapes, dimensions and/or surface characteristics.

The use of the above described flow-front projection and die fabrication methods enables an improved honeycomb manufacturing process, characterized by a low incidence of initial extrudate bowing, honeycomb channel distortion, and/or extrudate splitting. That method comprises the steps of, first, selecting a honeycomb extrusion die of a geometric design incorporating feedholes and interconnecting discharge slots suited for forming an extrudable material into a honeycomb extrudate of a selected geometry. Thereafter, and prior to forming the extrudable material into the extrudate, (i) flowfront variations across the outlet face of the extrusion die are projected from measurements of the geometric shapes, dimensions, and/or surface characteristics of the die feedholes and the die discharge slots at multiple sampling locations across the die outlet face, and (ii) the shapes, dimensions, and/or surface characteristics of the feedholes and/or discharge slots at one or more of such locations are modified to modify the projected flowfront variations across the die outlet face. Finally, the honeycomb extrudate of selected geometry is formed by forcing the extrudable material through the thus-modified honeycomb extrusion die.

### DESCRIPTION OF THE DRAWINGS

The invention is further described below with reference to the appended drawings, wherein:

FIG. 1 is a perspective view in partial cross-section of a portion of a honeycomb extrusion die of a design suitable for the shaping of extrudable ceramic powder materials into ceramic honeycombs;

FIG. 2 presents schematic views (a), (b) and (c) of selected portions or sections of an extrusion die such as illustrated in FIG. 1; and

FIG. 3 is a top plan view of the discharge face of a honeycomb extrusion die indicating a typical division of the die into extrusion zones for purposes of flowfront analysis.

### DETAILED DESCRIPTION

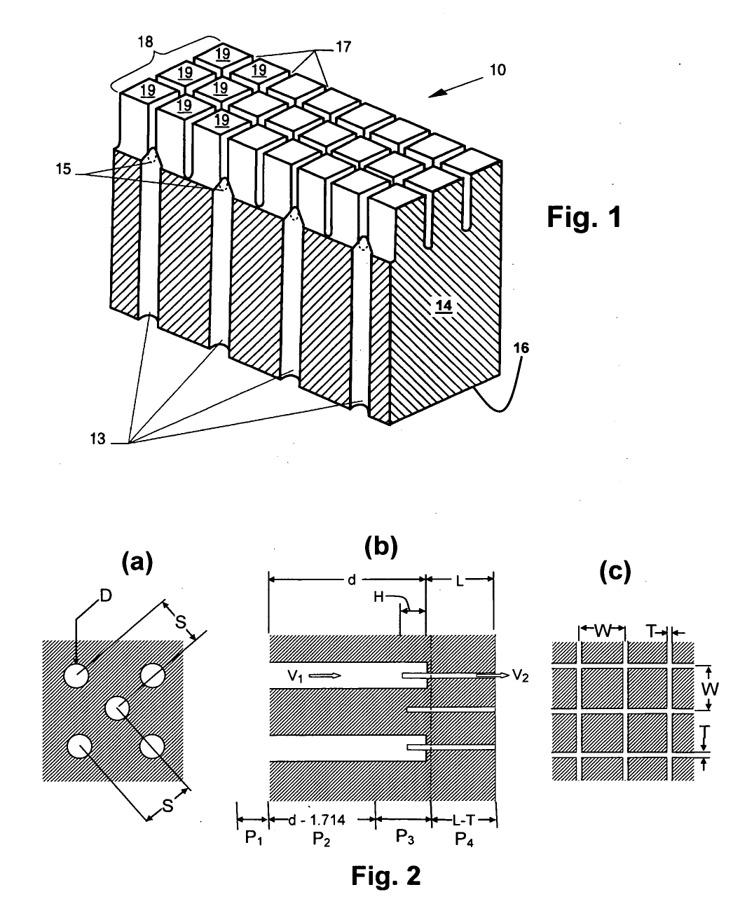

A schematic perspective view in partial cross-section of a section 10 of a conventional honeycomb extrusion die is presented in FIG. 1 of the drawings. As shown in that figure, extrusion die portion 10 comprises feed extrudate feedholes 13 extending upwardly into a die body 14 from a die inlet face 16 through which extrudable batch material is conveyed to feed hole/slot intersections 15, and from there into criss-crossing discharge slots 17. Discharge slots 17 then convey the batch material upwardly to outlet face 18 of the extrusion die where it exits the die in the configuration of a honeycomb.

The discharge slots 17 are bounded or formed by the side surfaces of pins 19, the latter being formed as the discharge slots are formed. Resistance to extrudate material flow is encountered as the extrudable material enters feedholes 13, as it traverses those feedholes, as it traverses feed hole/slot intersections 15, and as it moves through discharge slots 17.

In one convenient mode of application for the invention, an extrudate flowfront projection in the form an extrusion velocity map of the die outlet face is provided. To generate the map, each of a plurality of die sections or extrusion zones traversing the die from the inlet face to the outlet face in the direction of extrudate flow therethrough (e.g., the die section illustrated in FIG. 1 of the drawing), is separately analyzed based mainly on measurements of die attributes within that zone. These analyses permit an extrudate extrusion velocity at the outlet face for that zone to be projected. A flowfront map of the entire die outlet face incorporating all of the flow velocity projection results from all of the zones or sections then allows easy comparison of absolute or relative extrusion velocities for the various zones. That comparison provides a basis for predicting overall die performance or for applying remedial machining or coating measures to alter extrusion zone attributes, in order to modify target extrusion performance.

As noted above, any of the numerous methods that have been or may be used to modify local die attributes are available to manipulate the calculated extrusion velocity distributions during die manufacture. Similar analyses can also be used in the later run life of a die, should it be found desirable to modify the profile to convert the die to other product designs or process environments. Examples of suitable methods for locally modifying die attributes include selective abrasive flow machining, selective liquid or vapor plating, and/or selective electrochemical or electrical discharge re-machining or smoothing of feedholes, discharge slots and/or feedhole-slot intersections.

The ability to mathematically project the extrusion velocity profiles of dies at each stage of the die manufacturing process enables more effective use of manufacturing interventions that can enable the resulting die to meet required flowfront profiles even under particularly difficult extrusion conditions. For example, for some applications it may actually be desirable to provide a die with a varying slot width (e.g., smaller in the center and slightly wider on the periphery). Such a configuration would normally be expected to produce undesirable variations in flowfront extrusion velocity, but may in fact substantially improve extrusion results by compensating for non-uniform batch viscosity profiles resulting from non-uniform extrudate temperatures at the die inlet face. Thus optimal extrusion velocity profiles may well differ depending on the type of extrudable material and/or extrusion process being utilized.

A further use of the invention is to recalculate the velocity profiles of selected extrusion dies at various points during their run life, for example to ascertain die wear patterns that may be developing or to compensate for inherent extruder process wear patterns. Thus the useful lives of expensive extrusion dies can in many cases be significantly extended through the use of flow profiling analyses.

Another important benefit of flowfront analysis is to aid in the selection of peripheral forming hardware used, for example, to control skin thicknesses or to modify web thicknesses across the diameters of extruded honeycomb shapes. The initial selection and adjustment of peripheral hardware utilized to control skin thickness and skin extrusion velocity can more quickly be accomplished if the velocity distribution of the associated extrusion die is known. This represents a substantial improvement over conventional practice in which extrusion dies must first be evaluated on an extrusion line, with substantial waste and lost production time, before peripheral hardware adjustments can be completed.

Control of extrusion velocity profiles through dies of graded or other non-uniform slot widths is becoming increasingly important as advanced honeycomb designs featuring non-uniform web thicknesses are developed. Again the use of flowfront analyses enables the entire flowfront profile across each extrusion die to be effectively managed, even in cases where significant differences in extrusion die slot widths or shapes are required.

FIG. 2 of the drawing presents views of three different sections of a representative extrusion zone of a honeycomb extrusion die such as shown in FIG. 1, wherein measurable geometric features and flow parameters that can influence extrudate pressure drop across the die through that zone and thereby impact the resulting die flowfront profile are indicated. Die section (a) in FIG. 2 is a plan view of a section of a die inlet face 16 wherein the diameters D of the die feedholes 12 and the lateral spacing S of those feedholes are indicated.

Die section (b) in FIG. 2 is a side elevational cross-section of the extrusion zone indicating the lengths L of the discharge slots, the lengths d of the feedholes, and the lengths H of the extrudate feedhole-discharge slot overlap region. The flow velocity values V1 and V2 that indicate extrudate flow velocities for extrudable material traversing the feedholes and discharge slots, respectively, are also indicated. Finally, die section (c) is top plan view of the section of outlet face 20 for the extrusion zone, wherein the discharge slot spacing W and discharge width T are indicated.

Referring again to FIG. 2 and die section (b), the total pressure drop experienced by an extrudable material traversing an section of extrusion die such as shown can be equated to the sum of four regional pressures drops P1, P2, P3 and P4 indicated in the drawing. P1 corresponds to the pressure drop occurring as extrudable material is forced from the outlet of an extruder into the feedholes, while P2 is the pressure drop arising from frictional forces acting on the extrudable material as it traversed the feedholes. P3 is the pressure drop arising as the extrudable material is compressed and reshaped during traversal from the feedholes into the discharge slots, and P4 is the pressure drop arising from frictional forces acting on the extrudable material as it traverses the discharge slots.

Current understanding is that the various pressure fields developed when extrudable material flows through extrusion dies such as shown in FIGS. 1 and 2 could be calculated to a high degree accuracy utilizing advanced engineering tools and modern numerical simulation methods such as solid modeling and computational fluid dynamics. However, such calculations are numerically intensive, requiring specialized and expensive expertise and equipment, and have been considered of theoretical interest only.

An important aspect of the present invention is the development of more direct mathematical approaches that enable the mapping of honeycomb die flowfront shapes and extrusion speed variations with an accuracy sufficient for practical use in die fabrication and extruded honeycomb manufacture. One example of such approaches is a set of equations that can be used for calculating the pressure drops P1-P4 shown in FIG. 2 as described above, from data including the die attributes presented in that figure. These equations, set forth in Table 1 below, have been found to be generally suitable for the analysis of pressure drops through square-channeled honeycomb extrusion dies having feedholes provided on every other discharge slot intersection, typified by the die design shown in the drawings.

TABLE 1
Pressure Drop Equations

| Pressure | | |
|---|---|---|
| Variable | Description | Equation |
| P1 | Pressure | P1 = (a1_n*(LN(W*SQRT(2)/D))\hat{ }a2_n + |
| | drop at die | a3_n)*(TauYield + K*(V1/D)\hat{ }n) |
| | inlet | |
| P2 | Pressure | P2 = 4*((d − 1.714*D)/D)*(Beta*V1\hat{ }m* |
| | drop across | Ra_{feed}\hat{ }m′) |
| | feed holes | |
| P3 | Pressure | P3 = (0.007634*(H/T)\hat{ }2 − 0.1596* |
| | drop across | (H/T + 4.6762)*((0.04206*W/T) + 1) |
| | feed hole- | *(0.004*n *(D/T)\hat{ }2 − (0.1286*n − 0.01284)* |
| | slot | D/T + (1.0807*n + 1)*(1.5071*EXP(−0.7278* |
| | transition | m)*Beta *V2\hat{ }m + TauYield + K*(V2/T)\hat{ }n)) |
| P4 | Pressure | P4 = 1.4025*((L − T)/T)*Beta*V2\hat{ }m* |
| | drop across | Ra_{Slot}\hat{ }m′ + 1.4025*((SBL − BB)/BB)* |
| | discharge | Beta*V2\hat{ }m* Ra_{Slot}\hat{ }m′ |
| | slots | |

The above equations yield pressure drop calculations to a degree of accuracy sufficient to permit effective die flowfront analysis over a relatively wide range of extrusion rates and extrudable material compositions and properties, including those rates and compositions of present interest for the production of ceramic honeycombs from plasticized ceramic powder batches. In should be noted that the equations take into account not only the geometric parameters of the die, but also the properties of the extrudable material to be formed, the surface roughness of the die surfaces over which the material passes during extrusion, and the rates of extrusion intended to be employed.

A key advantage of the analytical approach presented in Table I is that the engineering calculations required for each of the four pressure drop zones can be completed, and applied to extrusion die design, individually and not just in combination. That is, the equation relating P1 to extrusion velocity is independent of P2-P4, and likewise for P2, P3 and P4. The possibility of decoupling these independent pressure drop factors had to be recognized before numerical methods enabling the individual computation of the pressure drop factors identified in Table 1 above could be conceived and developed.

The values of D, S, W, T, d, L, H, SBL and BB used in calculations based on the above equations will be determined from direct measurements of die geometry, while the surface roughness variables Ra_{feed} and Raₛₗₒₜ of the die feedhole and discharge slot surfaces, respectively, can be determined from profilometer measurements or optical inspection techniques of those die surfaces.

The various equation parameters not resulting from die geometry and surface measurements are fixed by the material characteristics of the extrudable material to be processed and the rate at which it is to be extruded, The flow velocities V1 and V2, the flow velocities of the extrudable material through the die feedholes and die discharge slots, respectively, are calculated from the extruder volumetric feed rate and the sizes of the slots and feedholes. The values for n, m, m′, TauYield, and beta are intrinsic to the extrudable material being processed, and are derived from the rheological properties of that material.

Extrudable plasticized ceramic powder batches can be treated for practical purposes as Herschel-Bulkley (non-Newtonian) fluids. As such, the values of the constants n, yield stress τ₀ (TauYield), and K that characterize the rheology of the batches are readily determinable, for example, from viscosimetry measurements on each extrudable material in accordance with known practice. The yield stress τ₀ and data points for shear stress τ as a function of shear rate γ are directly obtained from such measurements, and the values of the consistency constant K and the power law exponent n are then determined by curve-fitting the viscosimetry data to the Herschel-Bulkley shear stress equation:
τ=τ₀+K(γ)ⁿ
again where:
τ is shear stress
τ₀ is yield tress or TauYield
K is a consistency constant
γ is the shear rate, and
n is the power law exponent
   Alternatively, capillary rheometry data can be used to plot extrusion batch viscosity as a function of the strain rate, and the consistency constant K and the power law exponent n then determined from the equation: Viscosity=K * (Strain Rate)⁽ⁿ⁻¹⁾.

From the value of n computed in accordance with either method, the values of the variables a1_n, a2_n and a3_n used to compute P1 in accordance with Table I above are then derived from the following expressions:
a1_n=−1.2978n²+1.4721n+4.6485
a2_n=0.8611n²+1,0084n+0.7613
a3_n=5.2836n²+0.6738n+2.1941

Extrusion pressure drop through the die feedholes, corresponding generally to pressure drop P2 as discussed above, depends to a first approximation on wall shear stress τ_{w} which is related to beta (β) and wall slip velocity V_{w} according to the equation: τ_{w}=−β|V_{w}|^{m-1}*V_{w}. Beta and m can be determined for any particular extrudable batch material from wall shear stress rheology measurements over a range of known wall slip velocities V_{w}.

However, a better approach for evaluating feedhole pressure drop P2 takes into account the surface roughness Ra of the batch feedholes in addition to the wall slip velocity (V1 in Table 1). The value of the roughness exponent m′ from Table 1 can be determined for any particular extrudable batch material from shear stress rheology measurement data collected for a number of different wall surface roughnesses encompassing the range of surface finish values (Ra_{feed} values) typical of honeycomb extrusion die feedholes.

As Table 1 reflects, pressure drop P3, which is attributable to flow resistance arising as the extrudable material is forced from the die feedholes into the die discharge slots, is affected largely by the relative sizes of the die feedholes and discharge slots as well as the geometry of the feedhole-slot overlap region. Also important are the batch rheology constants beta, m and n, and the flow velocity V2 of the extrudable materials through the die discharge slots.

Finally, pressure drop P4 through the die discharge slots depends directly on the slot geometry of the die, including the slot width T, the slot length L, and, where the slot is tapered in width, the relative degree of slot taper as indicated by the slot base length SLB and amount of width change BB. Just as for the case of the feedholes, slot surface roughness Raₛₗₒₜ as well as the batch rheology constants beta, n, m and m′ are also factors.

Pressure drop evaluations made on production honeycomb dies with commercial batch mixtures have indicated that the values of the constants beta and m′ present in the Table 1 equations are the values most affected by changes in batch rheology. Accordingly we find that the values of these constants are best determined for each extrudable batch material through honeycomb extrusion trials rather than rheometry. One suitable procedure is to measure total extrusion pressure drop through a die of known geometry for a sample of the extrudable material to be characterized (equivalent to the sum of P1, P2, P3 and P4 discussed above) while at the same time calculating the sum of those pressures drops from the Table 1 equations using an approximated beta value. The pressure sum is then recalculated with beta adjustments until a beta value making the sum of the calculated partial pressures equal to the observed total pressure drop is found. This iterated beta value may then be used for all further pressure calculations involving the same extrudable material.

In actual practice, we have found that the certain simplifications of the Table 1 equations can be adopted without unduly impacting the value of the equations in predicting relative pressure drops and flow velocities as between the selected extrusion zones through the die. The most important of these simplifications a wall shear equation that can be used without disadvantage to predict pressure drop P4, as well as pressure drop P2, through the die. The simplification is based on the fact that the main determinant of these pressure drops, aside from the flow characteristics of the extrudable batch material, are the cross-sectional areas and surface areas of the flow channels.

A preferred wall shear equation that can be used to calculate both the P2 and P4 pressure drops is: ΔP=τ_{w}Aₛ/A_{cs}, where τ_{w}=β′V_{w}^{m}Ra^{m′}. In that equation, the terms Aₛ and A_{cs} are the surface and cross-sectional areas, respectively, of the feedholes and discharge slots of the die. The coefficients Vw, Ra, m and m′ are rheologically determined as above described, while β′ may be determined by iterative approximation in the same manner as beta described above.

The die extrusion zones to be defined or selected for pressure drop and extrusion speed determinations can be of any convenient size and location. Useful flowfront information can be obtained from analyses of as few as nine extrusion zones distributed across the outlet face of the die (i.e., data from a 3×3 zone matrix). However, it is presently preferred that pressure drop computations for at least 25 uniformly distributed extrusion zones, and more preferably for 49 zones (a 7×7 matrix) or more, will be carried out. For each of a predetermined number of die extrusion zones to be characterized, measurements of one or a number of feedholes and associated discharge slot sections within each extrusion zone can be made; our preferred practice is to fully characterize at least one feedhole and at least two horizontal and two vertical slot measurements for each separate extrusion zone to be defined.

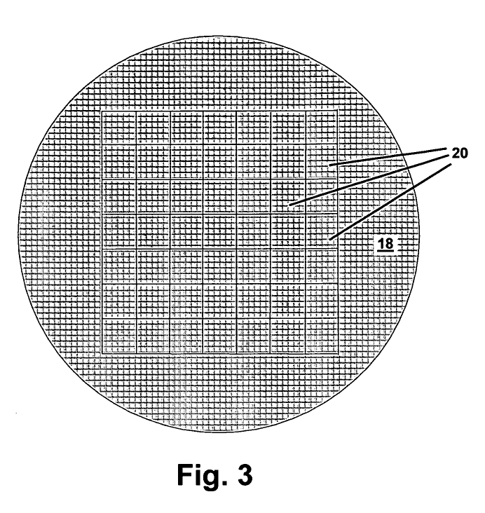

FIG. 3 of the drawing is a top plan view of the outlet face 18 of a honeycomb extrusion die that has been divided for analytical purposes into 49 separate extrusion or flowfront zones 20, these being projected onto the outlet face as a 7×7 matrix. The zones can be identified by row and column number.

Table 2 below sets forth representative measurements of die geometry that might result from measurements conducted on such projected extrusion zones. Included are measurements of feedhole diameter (Hole Dia values), feedhole surface roughness (Hole Ra values), discharge slot widths (Slot widths), and discharge slot cross-sectional area (Slot area) for each of the 49 zones selected. These data are illustrative of the types of variations in these parameters that can be observed during routine die fabrication.

TABLE 2
Geometric Die Variances - 49 Extrusion Zones
Hole Dia values:

| | | | | | | |
|---|---|---|---|---|---|---|
| 0.04343115 | 0.043610688 | 0.043715 | 0.043688 | 0.043733 | 0.043719 | 0.043625 |
| 0.043738217 | 0.043573861 | 0.043625 | 0.043754 | 0.043741 | 0.043793 | 0.04375 |
| 0.043647926 | 0.043654668 | 0.043676 | 0.043677 | 0.043622 | 0.043644 | 0.043686 |
| 0.043526732 | 0.04356941 | 0.043559 | 0.043618 | 0.043536 | 0.043514 | 0.043561 |
| 0.043467177 | 0.043510558 | 0.04356 | 0.043558 | 0.043517 | 0.04345 | 0.043526 |
| 0.043472624 | 0.043363847 | 0.043324 | 0.043318 | 0.043373 | 0.043446 | 0.043452 |
| 0.043160876 | 0.043365257 | 0.043369 | 0.043321 | 0.043318 | 0.043266 | 0.043095 |

Hole Ra values:

| | | | | | | |
|---|---|---|---|---|---|---|
| 13.49 | 11.82 | 9.05 | 7.9 | 7.91 | 10.58 | 6.21 |
| 15.55 | 11.02 | 8.06 | 11.88 | 0 | 14.31 | 8.3 |
| 6.43 | 16.57 | 9.01 | 10 | 13.09 | 8.25 | 7.36 |
| 10.2 | 9.67 | 15.63 | 7.96 | 11.32 | 8.48 | 8.74 |
| 9.99 | 12.74 | 11.46 | 9.52 | 15.46 | 21.11 | 6.68 |
| 9.57 | 7.66 | 12.06 | 12.69 | 7.98 | 6.77 | 10.62 |
| 10.28 | 8.1 | 20.95 | 12.47 | 13.09 | 7.77 | 11.93 |

Slot widths (in.)

| | | | | | | |
|---|---|---|---|---|---|---|
| 0.00292975 | 0.0028685 | 0.002877 | 0.002846 | 0.002846 | 0.002853 | 0.002936 |
| 0.00289175 | 0.0028155 | 0.002805 | 0.002803 | 0.002799 | 0.002788 | 0.002834 |
| 0.00288125 | 0.002844 | 0.002872 | 0.002816 | 0.00284 | 0.002808 | 0.002853 |
| 0.0028855 | 0.00287775 | 0.002884 | 0.00301 | 0.002878 | 0.00291 | 0.002855 |
| 0.00288525 | 0.002823 | 0.002882 | 0.002882 | 0.002799 | 0.002818 | 0.002884 |
| 0.00291975 | 0.00289 | 0.00289 | 0.002818 | 0.002851 | 0.002811 | 0.002859 |
| 0.00291925 | 0.0029045 | 0.002913 | 0.00286 | 0.002915 | 0.002877 | 0.002896 |

Slot area:

| | | | | | | |
|---|---|---|---|---|---|---|
| 0.000399154 | 0.000390561 | 0.000383 | 0.000381 | 0.000387 | 0.000395 | 0.000405 |
| 0.000387238 | 0.000380024 | 0.000376 | 0.000377 | 0.000379 | 0.000384 | 0.000391 |
| 0.000382554 | 0.000379519 | 0.000379 | 0.000381 | 0.000382 | 0.000383 | 0.000387 |
| 0.000384866 | 0.000382685 | 0.000386 | 0.000392 | 0.000388 | 0.000387 | 0.000389 |
| 0.000387033 | 0.00038396 | 0.000384 | 0.000388 | 0.000388 | 0.000389 | 0.000392 |
| 0.000394381 | 0.000389896 | 0.000388 | 0.00039 | 0.000392 | 0.000393 | 0.000397 |
| 0.00041469 | 0.000406735 | 0.000397 | 0.000394 | 0.000398 | 0.000407 | 0.000415 |

Where geometric variations of the magnitudes reflected in Table 2 above are present in an extrusion die, significant variations in extrusion speed, and thus flowfront shape, can be observed across the outlet face of the die. Table 3 below sets forth extrusion speed data in the form of relative extrudate velocities for a typical honeycomb extrusion die exhibiting such variations. The extrudate velocities are predictive of the magnitude of flowfront shape variations to be expected from the die. The relative extrudate velocities given are for 49 discrete extrusion zones of approximately equivalent area evenly distributed across the die outlet face. Equivalently, such variations could be reported as variations in flowfront distance from a reference plane, such as the die outlet face, that would arise over a given reference extrusion time interval given a die exhibiting the extrudate velocity variations shown in Table 3.

TABLE 3
Relative Extrudate Velocities - 49 Extrusion Zones

| A | B | C | D | E | F | G |
|---|---|---|---|---|---|---|
| 0.90150334 | 0.915707 | 0.874248 | 0.86507 | 0.936185 | 0.877335 | 0.877121 |
| 0.895491701 | 0.877547 | 0.871851 | 0.868618 | 0.857528 | 0.868722 | 0.882802 |
| 0.961055267 | 0.957838 | 0.845297 | 0.940779 | 0.946566 | 0.941418 | 0.862456 |
| 0.869529441 | 0.926283 | 0.955122 | 0.975254 | 0.890984 | 0.897175 | 0.891027 |
| 0.810554091 | 0.932923 | 0.928175 | 0.926539 | 0.935125 | 0.81839 | 0.802581 |
| 0.938259806 | 0.934892 | 0.931727 | 0.957091 | 0.941929 | 0.928505 | 0.936128 |
| 0.900703609 | 0.811916 | 0.911563 | 0.850019 | 0.859544 | 0.836474 | 0.865184 |

Calculated extrusion speed data such as reported in Table 3 can easily be analyzed to predict, for example, whether a particular extrusion die is likely to exhibit uneven extrusion when put into production. As a specific example, the bordered speed values from columns A and B of Table 3, corresponding to extrusion speeds calculated for 14 extrusion zones disposed on the left side of the honeycomb die outlet face, are compared with the extrusion speed data from bordered columns F and G reflecting extrusion speeds from 14 zones disposed on the right side of the die outlet face. Significant differences in the average extrusion speeds between the left and right extrusion zones have been found to be characteristic of extrusion dies later exhibiting left-right significant left-right “bowing” of the extrudate when put into production, i.e., a bending of the extrudate away from the direction or axis of extrusion in a left- or right-handed curve as it exits the extrusion die.

The more general application of statistical methods to the analysis of extrudate flow differentials observed in groups of extrusion dies employed to make similar products from similar extrudate compositions on similar manufacturing equipment has also been found quite effective in linking die extrusion performance to measured geometrical die feedhole and discharge slot attributes. Again, such analyses can enable die machining or coating intervention actions that can improve final die geometries and reduce or avoid the need for costly on-line die extrusion evaluations of each die.

As broadly characterized, the statistical method for predicting the extrusion flow characteristics and/or extrusion performance of a selected honeycomb extrusion die comprises the step of collecting extrudate flow variable data for a set of honeycomb extrusion dies having a die design matching the design of a selected honeycomb die to be evaluated. As previously noted, die extrusion characteristics resulting from extrudate velocity variables can include but are not limited to behaviors such as the extent of extrudate bow, the extent of extrudate extrusion velocity variations as between different regions of the die (left to right, top to bottom, die center to die periphery), and problematic excessive or deficient flow from sections of the skin-forming region around the die periphery. Some of the die extrusion characteristics may not give rise to immediately apparent extrudate defects, but are manifested in and can be statistically linked with downstream production defects such as honeycomb cracking that affect process yields over the course of the usable life of the die.

Additional performance data of interest for statistical analyses may relate other die performance metrics measuring the performance of a particular die design over its usable life in extrusion. Examples of such die performance metrics include die service life yields and die pressure drop performance. One die service life metric tracks the yield of acceptable honeycomb ware versus the volume of extrudate processed through the die during its service life, with statistical data being collected for set of honeycomb extrusion dies having a common die design to be evaluated.

Also collected for the same set of honeycomb extrusion dies is geometric variable data for the die set to be characterized for flow variables as above described. The geometric data may consist of one or many geometric attribute variables including, but not limited to die feedhole diameter, feedhole length, feedhole surface finish, discharge slot length, discharge slot surface finish, feedhole-slot transfer section dimensions, feedhole diameter taper, and discharge slot surface shape. The die geometric variables can be composed of raw measurement data, or may instead be constructed variables reflecting patterns of extrudate velocity variations across the die outlet face (top to bottom, left to right, center to outer), the constructed variables being based on averages, ranges or statistical measures such as T tests of the raw data.

Utilizing the flow variables, die performance metrics, and geometric attribute data thus collected, a correlation between at least one of the extrudate flow variables or die performance metrics and at least one of the die geometric attribute variables is next determined. With such a correlation in hand, the extrusion flow characteristics for a selected die of the die design for which the geometric and extrusion flow data has been correlated can readily be predicted, and even corrected.

The application of this statistical approach, rather than calculated pressure drop and extrudate velocity calculations, to similarly predict the expected extrudate quality and performance of a honeycomb extrusion die over the course of the dies usable life can be carried out as follows. Quantifiable die extrudate performance data over the usable extrusion time of the honeycomb extrusion die is first collected for a large population of honeycomb extrusion dies of a selected common design. Many feedhole and many discharge slot attributes of the kind above described are collected for that data set. The data thus collected are then statistically evaluated to identify geometric attribute patterns or raw attributes most strongly correlating with die extrudate performance over the usable extrusion time of the honeycomb extrusion die.

To expedite this analysis, the evaluations of the measured attributes are carried out for each of the measured attributes on 49 data sets, each set including data from one of 49 extrusion zones distributed in a 7×7 matrix over the discharge face of the extrusion die. The extrusion zone matrix illustrated in FIG. 3 of the appended drawings is an example of a useful matrix, and multiple (e.g., three to twelve) different matrix patterns of these 49 extrusion zones can be evaluated for attribute variances that may correlate with extrudate bow in that die design.

For the purpose of effectively predicting bowing behavior in such extrusion dies, both left-to-right and top-to-bottom bowing should be separately considered and analyzed. The matrix pattern most directly correlating with left-to-right bowing is found to be that comparing attribute data from the two leftmost matrix columns with those of the two rightmost columns of a 49-extrusion-zone data matrix containing attribute measurement data from an extrusion die patterned as shown in FIG. 3 of the drawing. Similarly, top-to-bottom bowing correlates best with a matrix pattern comparing data from the top two rows of the matrix with data from the bottom two rows. The die attributes best correlating with these bowing behaviors after analysis of the attribute measurement data are found to be: outer discharge slot width, feedhole roughness, feedhole diameter, and inner discharge slot width, for the particular die design selected for analysis.

Once the strongest die-attribute/extrudate-bowing correlations have been determined for the selected die design as above described, then measuring only those attributes within only those extrusion zones for any selected extrusion die of the same design and intended for use in the same production environment provides a valuable predictor of the extrudate bowing behavior most likely to be exhibited by that extrusion die. Then, as previously noted, any one of a number of known techniques can be employed to modify those geometric die attributes and thus the resulting die extrusion characteristics. Accordingly, the extrusion characteristics of any particular honeycomb extrusion die can be adjusted in advance of commercial use to bring the calculated pressure drops or statistically determined extrusion characteristics into closer alignment with a desired extrusion speed distribution or extrudate flowfront profile.

As examples of suitable modification methods, feedhole diameters and slot sizes, as well as the surface roughness of the feedholes and slots, can be modified within selected extrusion zones across the die outlet face by selective machining, e.g., by abrasive flow, electrochemical, or electrical discharge machining. Alternatively or in addition, slot dimensions and surface finishes can be locally adjusted by applying preferential liquid or chemical vapor coating processes. In any event, analyses such as described can be used to determine the limits of flowfront variability that should be observed in order to avoid putting into production extrusion dies that are unlikely to produce saleable wear within a reasonable time from die start-up.

The foregoing examples are merely illustrative of applications for the invention that may be practiced within the scope of the appended claims.

We claim:

1. A method for predicting extrudate flow differentials across the outlet face of a honeycomb extrusion die comprising an array of feedholes intersecting a criss-crossing array of discharge slots on the outlet face which comprises the steps of:
measuring one or more geometric die parameters pertaining to the feedholes, the discharge slots and/or feedhole-discharge slot intersections for multiple extrusion zones through the die; and
employing the measured geometric die parameters to predict extrudate flow differentials through each of the extrusion zones

2. A method in accordance with claim 1 wherein the geometric die parameters include parameters selected from the group consisting of feedhole diameter, feedhole length, feedhole surface finish, discharge slot length, discharge slot surface finish, feedhole-slot transfer section dimensions, feedhole diameter taper, and discharge slot surface shape.

3. A method in accordance with claim 1 wherein the extrudate flow differentials are predicted from calculations of the relative magnitudes of one or more extrudate pressure drops within each of the extrusion zones.

4. A method in accordance with claim 3 wherein the extrudate flow differentials are predicted from the relative magnitudes of a single extrudate pressure drop selected from the group consisting of (i) pressure drop at a die inlet face; (ii) pressure drop across die extrudate feedholes; (iii) pressure drop across die feedhole-slot intersections; and (iv) pressure drop across die discharge slots.

5. A method in accordance with claim 3 wherein the extrudate flow differentials are predicted from the relative magnitudes of two or more extrudate pressure drops.

6. A method in accordance with claim 1 wherein the extrudate flow differentials (i) give rise to extrudate bow or honeycomb cell distortion in the extrudate, and (ii) are predicted by reference to a data set correlating such differentials with patterns of variation for the geometric die parameters across the multiple extrusion zones of the honeycomb extrusion die.

7. A method for making a honeycomb extrusion die comprising the steps of:
shaping one or more die preform components into a honeycomb extrusion die incorporating an extrudate inlet feedhole section; a honeycomb discharge slot section, a feedhole-slot extrudate transfer section, and a die outlet face;
calculating relative extrudate pressure drops within multiple extrusion zones extending through the die and projecting onto the die outlet face; and
modifying the geometry of the feedhole section, discharge slot section and/or feedhole-slot extrudate transfer section within at least one of the extrusion zones to modify extrudate flow impedance through that extrusion zone.

8. A method for making a honeycomb extrusion die in accordance with claim 7 wherein the step of calculating relative extrudate pressure drops employs one or more die geometry variables selected from the group consisting of feedhole diameter, feedhole length, feedhole surface finish, discharge slot length, discharge slot surface finish, and feedhole-slot transfer section dimensions.

9. A method for manufacturing a ceramic honeycomb body which comprises the steps of:
selecting a honeycomb extrusion die of a geometric design incorporating feedholes extending inwardly from a die inlet face to interconnect with criss-crossing discharge slots extending inwardly from a die outlet face, the die being adapted to form an extrudable material into a honeycomb extrudate of a selected geometry;
prior to forming the extrudable material into the extrudate,
(i) calculating extrudate flow at multiple sampling locations across the die outlet face from pressure drops calculated for multiple extrusion zones through the die at the sampling locations; and
(ii) modifying shapes, dimensions, and/or surface characteristics of the feedholes and/or the discharge slots for only one or some of the extrusion zones to modify extrudate flow through such zones; and
forming a honeycomb extrudate of selected geometry by forcing the extrudable material through the thus-modified honeycomb extrusion die.

10. A method for predicting the extrusion flow characteristics of a selected honeycomb extrusion die comprising the steps of:
collecting extrudate flow variable data or die performance data for a set of honeycomb extrusion dies having a die design matching the selected extrusion die;
collecting die geometric variable data for the set of honeycomb extrusion dies;
determining a correlation between at least one extrudate flow variable and at least one die geometric variable; and
evaluating the at least one die geometric variable for the selected die and predicting the at least one extrudate flow variable for the selected die from the correlation.

11. A method in accordance with claim 10 wherein the at least one extrudate flow variable is selected from the group consisting of die service life yields, die pressure drop performance, and extrudate top-to-bottom, left-to-right, and die center-to-die periphery extrudate flow velocity differentials.

12. A method in accordance with claim 10 wherein the at least one die geometric variable is selected from the group consisting of feedhole diameter, feedhole length, feedhole surface finish, discharge slot length, discharge slot surface finish, feedhole-slot transfer section dimensions, feedhole diameter taper, and discharge slot surface shape.

13. A method in accordance with claim 10 wherein the step of collecting die performance data comprises collecting data respecting a yield of acceptable honeycomb ware and a volume of extrudate processed through an extrusion die, for a set of extrusion dies of a selected die design.

14. A method in accordance with claim 10 wherein the step of collecting die geometric variables comprises constructing such variables from averages, ranges or other statistical measures of extrusion data respecting patterns of extrudate flow variation through dies of a selected die design.
